(19) United States
(12) Patent Application Publication
(10) Pub. No.: US 2019/0134436 A1
(43) Pub. Date: May 9, 2019

(54) HEADNET FOR FIRST RESPONDERS

(71) Applicant: SCOTT TECHNOLOGIES, INC., Monroe, NC (US)

(72) Inventors: Darin Kyle Thompson, Huntersville, NC (US); Judge W. Morgan, III, Oakboro, NC (US); Jeffrey Scott Vogus, Monroe, NC (US)

(21) Appl. No.: 16/093,734

(22) PCT Filed: Apr. 13, 2017
(86) PCT No.: PCT/US2017/027337

§ 371 Date: Oct. 15, 2018

Related U.S. Application Data
(60) Provisional application No. 62/322,913, filed on Apr. 15, 2016.

(51) Int. Cl. A62B 18/08; A42B 1/04; A42B 1/24

(52) U.S. Cl. CPC A62B 18/084; A42B 1/24; A42B 1/041

(57) ABSTRACT

A headnet (20) for first responders has a net lattice (22) formed to cover the first responder's head (100) from the first responder's frontal bone area (102) to the occipital bone area (104) in support of protective turnout gear for respiratory protection (44) with a first set of straps (24a, 24b) extending forward from a level approximate to the intersection of the first responder's parietal bone (108) and occipital bone (104) and a second set of straps (28a, 28b) extending forward from a level approximate to the lower portion of the first responder's occipital bone (104). The headnet (22) has an opening (36) formed within the headnet (22) that is vertically centered with the back of the first responder and horizontally between the two straps (24, 28), having sufficient area in either an extended state or non-extended state to pull through the first responder's hair (46).

### TECHNICAL FIELD

The present invention relates to a personal protective equipment, and in particular to a method and system for ensuring proper fit of personal protective equipment on a wearer, such as a first responder, having long hair.

### BACKGROUND

Many types of personal protective equipment worn by first responders include a headnet. For example, a headnet may be strapped or coupled to a faceplate for a respiration system and used to support the faceplate on the wearer's face. The headnet may enclose all or a substantial portion of the wearer's head.

First responders, such as firefighters, with long hair are presented with problems of respiratory equipment not fitting properly. As seen in FIG. 1 known respiratory gear includes a headnet 10 to support a facepiece that protects the first responder. The currently known headnet 10 may generally include one or more straps 12 connected to an at least substantially continuous head covering 14. However, as the head covering 14 portion of the headnet 10 covers all or a substantial portion of the back of the wearer's head, his or her hair can become bunched or tangled inside the headnet. This can not only present discomfort for the wearer, but can also compromise a proper fit of the headnet and possibly a seal of the facepiece against the wearer's face.

### SUMMARY

The present invention advantageously provides a method and system for ensuring proper fit of personal protective equipment on a wearer, such as a first responder, having long hair. A headnet for first responders includes a head covering, the head covering formed to cover the wearer's head from the wearer's frontal bone area to the occipital bone area in support of protective turnout gear for respiratory protection, a first set of straps, the first set of straps including a left extending strap and a right extending strap with both straps extending laterally from the head covering forward to each side of the wearer's face at a level approximate to the intersection of the wearer's parietal bone and occipital bone, a second set of straps, the second set of straps including a left extending strap and a right extending strap with both straps extending laterally from the head covering forward to each side of the wearer's face at a level approximate to the lower portion of the wearer's occipital bone and an opening formed within the head covering, the opening vertically centered with the back of the wearer and horizontally between the first set and second set of straps, the opening having sufficient area in either an extended state or non-extended state to pull through the wearer's hair.

In one embodiment, headnet for use with personal protective equipment includes a head covering including an opening, a first pair of straps coupled to the head covering, and a second pair of straps coupled to the head covering, the second pair of straps being a predetermined distance from the first pair of straps, the opening being located between the first and second pair of straps.

In one aspect of the embodiment, the head covering further includes an edge portion, the edge portion having a first area and a second area opposite the first area. In one aspect of the embodiment, the first pair of straps includes a first strap coupled to the edge portion first area and extending laterally from the head covering in a first direction and a second strap coupled to the edge portion second area and extending laterally from the head covering in a second direction opposite the first direction. In one aspect of the embodiment, the second pair of straps includes a third strap coupled to the edge portion first area and extending laterally from the head covering in the first direction and a fourth strap coupled to the edge portion second area and extending laterally from the head covering in the second direction. In one aspect of the embodiment, the edge portion further has a third area and a fourth area opposite the third area, the headnet further comprising a third pair of straps coupled to the head covering, the third pair of straps including a fifth strap coupled to the edge portion third area and extending laterally from the head covering in a third direction and a sixth strap coupled to the edge portion fourth area and extending laterally from the head covering in a fourth direction opposite the third direction.

In one aspect of the embodiment, the opening has an edge portion that is reinforced.

In one aspect of the embodiment, the first and second pairs of straps are couplable to a personal protective equipment mask facepiece. In one aspect of the embodiment, the headnet is configured to be worn under at least one of a hood and a helmet.

In one aspect of the embodiment, the opening has an area of between 1.5 in² and 13.5 in². In one aspect of the embodiment, the opening has an area of between 2.4 in² and 4 in².

In one aspect of the embodiment, the head covering is composed of at least one of a para-aramid synthetic fiber, polyester, and nylon.

In one aspect of the embodiment, the head covering is composed of at least one of silicone and rubber.

In one embodiment, a headnet for use with personal protective equipment includes: an edge portion having a first area and a second area opposite the first area; a first pocket extending from the edge portion first area to the edge portion second area; a second pocket located a predetermined distance from the first pocket, the second pocket extending from the edge portion first area to the edge portion second area; and an aperture between the first and second pockets; a first strap having a first portion extending from the edge portion first area in a first direction and a second portion extending from the edge portion second area in a second direction opposite the first direction, at least a portion of the first strap being within the first pocket; and a second strap having a first portion extending from the edge portion first area in the first direction and a second portion extending from the edge portion second area in the second direction, at least a portion of the second strap being within the second pocket.

In one aspect of the embodiment, the aperture has an area of between 2.4 in² and 4 in².

In one aspect of the embodiment, the aperture has an edge portion that is reinforced.

In one aspect of the embodiment, the first and second straps are couplable to a personal protective equipment mask facepiece, the headnet being configured to be worn under at least one of a hood and a helmet of a first responder.

In one aspect of the embodiment, the edge portion further has a third area and a fourth area opposite the third area, the headnet further comprising a third strap extending from the edge portion third area in a third direction and a fourth strap extending from the edge portion fourth area in a fourth direction opposite the third direction.

In one embodiment, a headnet for personal protective equipment configured to be worn by a wearer having hair includes: a head covering, the head covering formed to cover the wearer's head, the head having a face, a frontal bone area, a parietal bone area, and an occipital bone area, the head covering being configured to cover the wearer's head from the frontal bone area to the occipital bone area and to support protective turnout gear for respiratory protection; a first set of straps, the first set of straps including a left-extending strap and a right-extending strap with both straps extending laterally from the head covering and forward to each side of the wearer's face at a level approximate to the intersection of the wearer's parietal bone area and occipital bone area; a second set of straps, the second set of straps including a left-extending strap and a right-extending strap with both straps extending laterally from the head covering and forward to each side of the wearer's face at a level approximate to a lower portion of the wearer's occipital bone; and an opening formed within the head covering, the opening being vertically centered with a back of the wearer's head and being horizontally centered between the first and second sets of straps, the opening having sufficient area for at least a portion of the wearer's hair to pass therethrough.

In one aspect of the embodiment, the opening has an area of between 2.4 in² and 4 in².

In one aspect of the embodiment, the opening has an edge portion that is reinforced.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows a rear view of a prior art headnet, the headnet being a component of a personal protective equipment system;

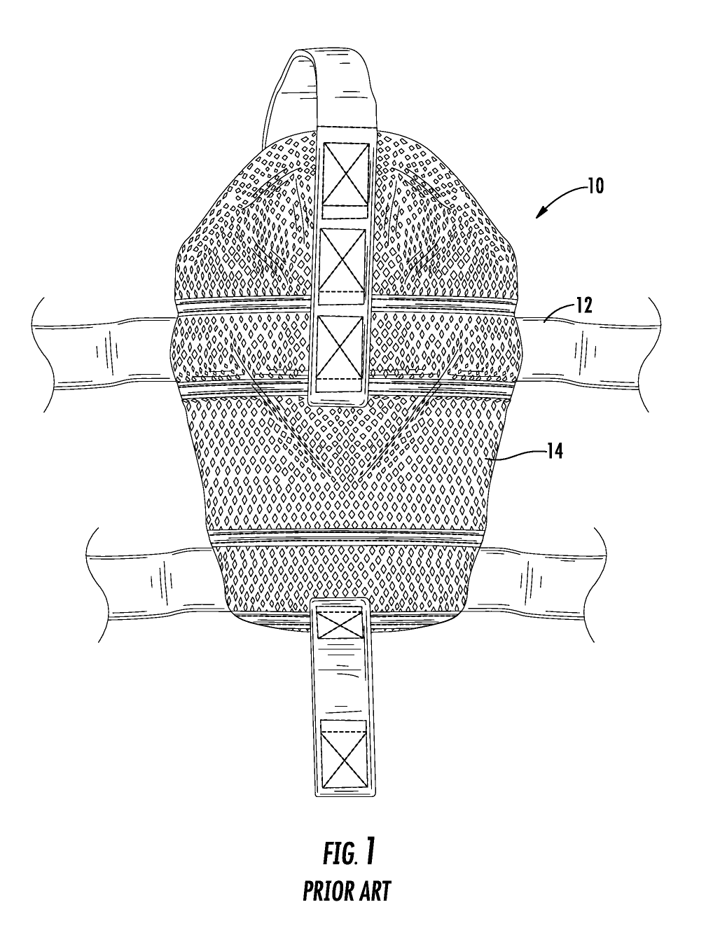

FIG. 2 shows a rear view of a headnet of the invention having an opening formed therein, the headnet being a component of a personal protective equipment system;

FIG. 3 shows a simplified depiction of parts of the human head referenced herein; and

FIG. 4 shows a simplified depiction of a headnet of the present invention in use.

### DETAILED DESCRIPTION

Before describing in detail exemplary embodiments that are in accordance with the disclosure, it is noted that components have been represented where appropriate by convention symbols in drawings, showing only those specific details that are pertinent to understanding the embodiments of the disclosure so as not to obscure the disclosure with details that will be readily apparent to those of ordinary skill in the art having the benefit of the description herein.

As used herein, relational terms, such as “first,” “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein. As discussed herein, a headnet provided in accordance with some embodiments for use with personal protective equipment may include an opening sized and configured for a wearer to pull at least a portion of the wearer's hair therethrough.

Referring now to the drawing figures in which like reference designations refer to like elements, an embodiment of a headnet for use with a personal protective equipment system constructed in accordance with the principles of the invention is shown in the figures and is generally designated as “20.”

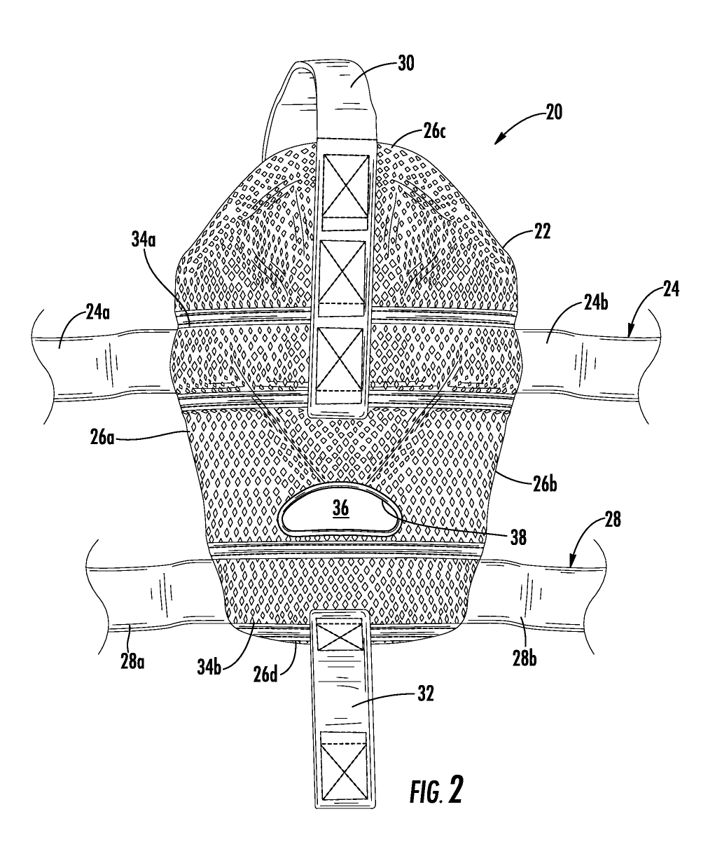

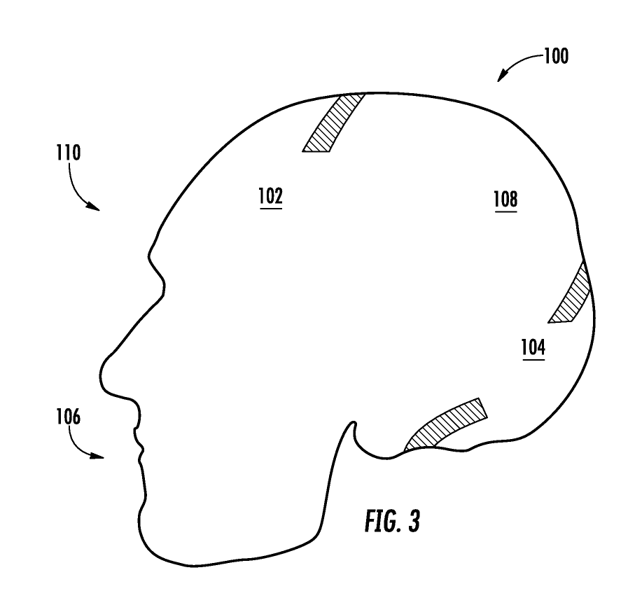

Referring to FIGS. 2 and 3, some embodiments include a headnet 20 for a wearer, such as a first responder. The headnet 20 includes a head covering 22 that is formed to cover the wearer's head 100 from the wearer's frontal bone area 102 to the occipital bone area 104 in support of protective turnout gear for respiratory protection. For example, the headnet 20 may include a plurality of straps for fastening the headnet 20 to a facepiece that includes a respirator and a faceplate. The headnet 20 may be configured to be worn under a hood and, depending on the use, a helmet (for example, a first responder helmet, such as that of a fire fighter, or a military helmet). The head covering 22 may include any appropriate elastic or non-elastic material for supporting respiratory equipment for use in firefighting and other emergency personnel situations with selection of such materials determinable by those skilled in the art of emergency protective personnel equipment. In one embodiment, the head covering 22 includes a lattice pattern of interweaving strands of material forming a support structure with open weave or net construction. The material may be a fabric, such as para-aramid synthetic fiber (for example, KEVLAR®), polyester, nylon, or the like. Additionally or alternatively, the material may be silicone or rubber.

A first pair or set of straps 24 includes a first strap 24a extending away from the headnet 20 in a first direction (this may be referred to herein as a first left-extending strap 24a) and a second strap 24b extending away from the headnet 20 in a second direction opposite the first direction (this may be referred to herein as first right-extending strap 24b). Both straps 24a, 24b extend laterally in opposite directions from the head covering 22, the first strap 24a extending from a first area 26a of the edge portion 26 of the head covering 22 and the second strap 24b extending from a second area 26b of the edge portion 26 of the head covering 22 opposite the first edge area 26a. The straps 24a, 24b also extend forward to each side of the wearer's face 106 at a level approximate to the intersection of the first responder's parietal bone area 108 and occipital bone area 104. Alternatively, the first 24a and second 24b straps may be a first portion 24a and a second portion 24b of a single strap 24 that extends across a width of the head covering 22. A second pair or set of straps 28 is located a predetermined distance from the first set of straps 24a, 24b and includes a third strap 28a extending in the first direction (this may be referred to herein as a second left-extending strap 28a) and a fourth strap 28b extending in the second direction (this may be referred to herein as a second right-extending strap 28b). Both straps 28a, 28b extend laterally in opposite directions from the head covering 22, the third strap 28a extending from the first edge area 26a and the fourth strap 28b extending from the second edge area 26b of the head covering 22. The straps 28a, 28b also extend forward to each side of the wearer's face 106 at a level approximate to the lower portion of the first responder's occipital bone area 104. Alternatively, the first 28a and second 28b straps may be a first portion 28a and a second portion 28b of a single strap 28 that extends across a width of the head covering 22. Optionally, additional straps may be added. For example, the headnet 20 may include a third set of straps including a fifth strap 30 extending from a third area 26c of the edge portion 26 of the head covering 22 toward the wearer's forehead area 110 (this may be referred to herein as a top strap 30) and/or a sixth strap 32 at the bottom of the head covering 22 (that is, extending from a fourth area 26d of the edge portion 26 of the head covering 22 opposite the third area 26c) to aid in fitting the head covering 22 while donning turnout gear (this may be referred to herein as a bottom strap 32). When the headnet 20 is in use with a faceplate, the edge portion 26 of the headnet 20 may be a free edge, meaning that the headnet 20 is attached to the faceplate by the straps 24, 28, 30, 32 and is not directly coupled to the faceplate. In alternative embodiments, however, at least a portion of the edge portion 26 may be directly coupled to or in contact with a portion of the faceplate.

The straps 24, 28, 30, 32 may be coupled to the edge portion 26 of the head covering by any suitable means, such as stitching, adhesives, chemical or thermal bonding, and/or attachment devices such as staples, snaps, latches, buckles or the like. Additionally or alternatively, the straps 24, 28 may each extend across a width of the head covering 22, optionally within a pocket or channel 34 defined by or located on or within the head covering 22. In this configuration, the straps 24, 28 may be slidable within the channels 34a, 34b to allow for a greater degree of adjustment of the personal protective equipment on the user's head.

An aperture or opening 36 is formed within the head covering 22 that is vertically centered with the back of the wearer's head 100 and horizontally centered between the first set 24a, 24b and second set 28a, 28b of straps with the opening 36 having sufficient area in either an extended state or non-extended state to pull the wearer's hair through the opening 36. Further, the opening 36 may be located between the first set 24 and second set 28 of straps. The opening 36 has sufficient area to pull a variety of hair types and hairstyles therethrough, including various lengths and thicknesses, ponytails, hair buns, loose hair, and other like hair dress, and combinations thereof. The shape of the opening 36 may be any functionally sufficient design for passing hair through the opening 36. As non-limiting examples, the opening 36 may have a shape such as a slit, a circle, an oval, a polygon such as a square, rectangle, pentagon, or the like. In one embodiment, an oval is used. The size of the opening 36 may be equivalent to an area of from about 1 in² to about 14 in², such as from about 1.5 in² to about 13.5 in², or, more specifically, from about 2.4 in² to about 4 in². The headnet 20 may be composed of any suitable material, including elastic and non-elastic materials as are known in the art. Opening 36 sizes include the opening 36 extended for both non-elastic and elastic materials forced to its greatest area expansion without structural damage. In one embodiment, the openings 36 is formed within the headnet 20 composed of one or more non-elastic materials, and the edge 38 of the opening 36 is reinforced. For example, the edge 38 of the opening 36 may include stitching, multiple layers of material, or the like to strengthen the edge 38 and prevent structural damage when the wearer's hair is pulled through.

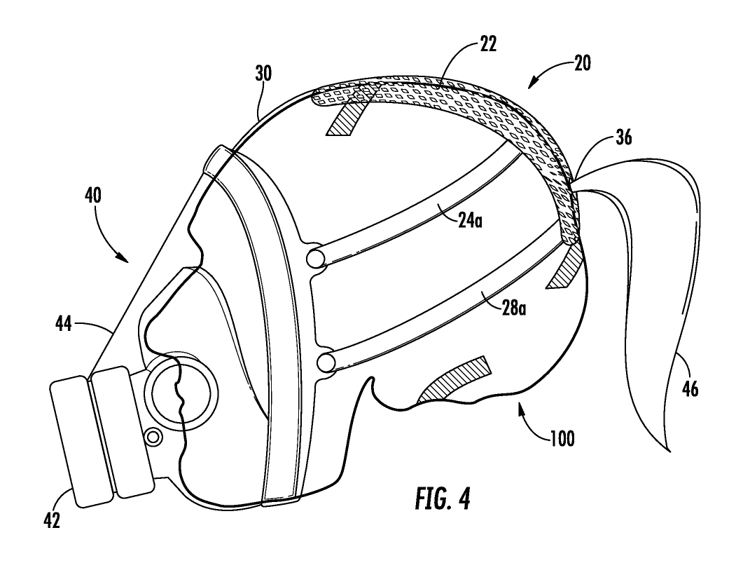

Referring now to FIG. 4, a simplified depiction of a headnet 20 in use is shown. As a non-limiting example, the headnet 20 may include a plurality of straps 24, 28, 30, 32 that are coupled or couplable to a personal protective equipment respiratory mask 40 that generally includes a respirator 42 and a facepiece 44. In use, the wearer dons a facepiece connected to a headnet 20 by pulling the headnet 20 up from the back of the wearer's head 100 to the wearer's forehead 110. The wearer grabs her/his hair 46 from underneath the headnet 20 in one hand while extending the headnet 20 away from her/his head 100 and inserts the hair through the opening 36 in the headnet 20. The headnet 20 is then allowed to become unextended, which fits the headnet 20 against the wearer's head 100 with the wearer's hair extending through the opening 36, thereby allowing a better fit of the headnet 20 on the wearer's head 100.

In one embodiment, headnet 20 for use with personal protective equipment includes a head covering 22 including an opening 36, a first pair of straps 24a, 24b coupled to the head covering 22, and a second pair of straps 28a, 28b coupled to the head covering 22, the second pair of straps 28a, 28b being a predetermined distance from the first pair of straps 24a, 24b, the opening 36 being located between the first 24a, 24b and second 28a, 28b pair of straps.

In one aspect of the embodiment, the head covering 22 further includes an edge portion 26, the edge portion having a first area 26a and a second area 26b opposite the first area 26a. In one aspect of the embodiment, the first pair of straps 24a, 24b includes a first strap 24a coupled to the edge portion first area 26a and extending laterally from the head covering 22 in a first direction and a second strap 24b coupled to the edge portion second area 26b and extending laterally from the head covering 22 in a second direction opposite the first direction. In one aspect of the embodiment, the second pair of straps 28a, 28b includes a third strap 28a coupled to the edge portion first area 26a and extending laterally from the head covering 22 in the first direction and a fourth strap 28b coupled to the edge portion second area 26b and extending laterally from the head covering 22 in the second direction. In one aspect of the embodiment, the edge portion 26 further has a third area 26c and a fourth area 26d opposite the third area 26c, the headnet 20 further comprising a third pair of straps 30, 32 coupled to the head covering, the third pair of straps including a fifth strap 30 coupled to the edge portion third area 26c and extending laterally from the head covering 22 in a third direction and a sixth strap 32 coupled to the edge portion fourth area 26d and extending laterally from the head covering 22 in a fourth direction opposite the third direction.

In one aspect of the embodiment, the opening 36 has an edge portion 38 that is reinforced.

In one aspect of the embodiment, the first 24a, 24b and second 28a, 28b pairs of straps are couplable to a personal protective equipment mask facepiece 44. In one aspect of the embodiment, the headnet 20 is configured to be worn under at least one of a hood and a helmet.

In one aspect of the embodiment, the opening 36 has an area of between 1.5 in² and 13.5 in². In one aspect of the embodiment, the opening 36 has an area of between 2.4 in² and 4 in².

In one aspect of the embodiment, the head covering 20 is composed of at least one of a para-aramid synthetic fiber, polyester, and nylon.

In one aspect of the embodiment, the head covering 20 is composed of at least one of silicone and rubber.

In one embodiment, a headnet 20 for use with personal protective equipment includes: an edge portion 26 having a first area 26a and a second area 26b opposite the first area 26a; a first pocket 34a extending from the edge portion first area 26a to the edge portion second area 26b; a second pocket 34b located a predetermined distance from the first pocket 34a, the second pocket 34b extending from the edge portion first area 26a to the edge portion second area 26b; and an aperture 36 between the first 34a and second 34b pockets; a first strap 24 having a first portion 24a extending from the edge portion first area 26a in a first direction and a second portion 24b extending from the edge portion second area 26b in a second direction opposite the first direction, at least a portion of the first strap 24 being within the first pocket 34a; and a second strap 28 having a first portion 28a extending from the edge portion first area 26a in the first direction and a second portion 28b extending from the edge portion second area 26b in the second direction, at least a portion of the second strap 28 being within the second pocket 34b.

In one aspect of the embodiment, the aperture 36 has an area of between 2.4 in² and 4 in².

In one aspect of the embodiment, the aperture 36 has an edge portion 38 that is reinforced.

In one aspect of the embodiment, the first 24 and second 28 straps are couplable to a personal protective equipment mask facepiece 44, the headnet 20 being configured to be worn under at least one of a hood and a helmet of a first responder.

In one aspect of the embodiment, the edge portion 26 further has a third area 26c and a fourth area 26d opposite the third area 26c, the headnet 20 further comprising a third strap 30 extending from the edge portion third area 26c in a third direction and a fourth strap 32 extending from the edge portion fourth area 26d in a fourth direction opposite the third direction.

In one embodiment, a headnet 20 for personal protective equipment configured to be worn by a wearer having hair 46 includes: a head covering 22, the head covering 22 formed to cover the wearer's head 100, the head 100 having a face 106, a frontal bone area 102, a parietal bone area 108, and an occipital bone area 104, the head covering 22 being configured to cover the wearer's head 100 from the frontal bone area 102 to the occipital bone area 104 and to support protective turnout gear for respiratory protection; a first set of straps 24a, 24b, the first set of straps 24a, 24b including a left-extending strap 24a and a right-extending strap 24b with both straps 24a, 24b extending laterally from the head covering 22 and forward to each side of the wearer's face 106 at a level approximate to the intersection of the wearer's parietal bone area 108 and occipital bone area 104; a second set of straps 28a, 28b, the second set of straps 28a, 28b including a left-extending strap 28a and a right-extending strap 28b with both straps 28a, 28b extending laterally from the head covering 22 and forward to each side of the wearer's face 106 at a level approximate to a lower portion of the wearer's occipital bone area 104; and an opening 36 formed within the head covering 22, the opening 36 being vertically centered with a back of the wearer's head 100 and being horizontally centered between the first 24a, 24b and second 28a, 28b sets of straps, the opening 36 having sufficient area for at least a portion of the wearer's hair 46 to pass therethrough.

In one aspect of the embodiment, the opening 36 has an area of between 2.4 in² and 4 in².

In one aspect of the embodiment, the opening 36 has an edge portion 38 that is reinforced.

Other embodiments may include:

### Embodiment 1

A headnet for first responders, the headnet comprising:

a head covering, the head covering formed to cover the first responder's head from the first responder's frontal bone area to the occipital bone area in support of protective turnout gear for respiratory protection;

a first set of straps, the first set of straps including a left extending strap and a right extending strap with both straps extending laterally from the head covering forward to each side of the first responder's face at a level approximate to the intersection of the first responder's parietal bone and occipital bone;

a second set of straps, the second set of straps including a left extending strap and a right extending strap with both straps extending laterally from the head covering forward to each side of the first responder's face at a level approximate to the lower portion of the first responder's occipital bone; and,

an opening formed within the head covering, the opening vertically centered with the back of the first responder and horizontally between the first set and second set of straps, the opening having sufficient area in either an extended state or non-extended state to pull through the first responder's hair.

### Embodiment 2

The headnet of Embodiment 1, further comprising a top strap extending to the forehead area of the first responder.

### Embodiment 3

The headnet of Embodiment 1, wherein the formed opening has sufficient area to pull through a hairstyle selected from the group consisting of ponytail, hair bun, loose hair, and combinations thereof.

### Embodiment 4

The headnet of Embodiment 1, wherein the formed opening is a shape selected from the group consisting of slit, oval, circular, square, rectangle, polygon and combinations thereof.

### Embodiment 5

The headnet of Embodiment 1, wherein the head covering is non-elastic.

### Embodiment 6

The headnet of Embodiment 5, wherein the formed opening includes reinforced edges.

### Embodiment 7

The headnet of Embodiment 1, wherein the head covering is elastic.

### Embodiment 8

The headnet of Embodiment 1, wherein the head covering comprises a net lattice.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the scope of the claims will be apparent to those of skill in the art upon reviewing the above description.

The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A headnet (20) for use with personal protective equipment, the headnet (20) comprising:
a head covering (22) including an opening (36);
a first pair of straps (24a, 24b) coupled to the head covering (22); and
a second pair of straps (28a, 28b) coupled to the head covering (22), the second pair of straps (28a, 28b) being a predetermined distance from the first pair of straps (24a, 24b), the opening (36) being located between the first (24a, 24b) and second (28a, 28b) pair of straps.

2. The headnet (20) of claim 1, wherein the head covering (22) further includes an edge portion (26), the edge portion (26) having a first area (26a) and a second area (26b) opposite the first area (26a).

3. The headnet (20) of claim 2, wherein the first pair of straps (24a, 24b) includes:
a first strap (24a) coupled to the edge portion first area (26a) and extending laterally from the head covering (22) in a first direction; and
a second strap (24b) coupled to the edge portion second area (26b) and extending laterally from the head covering (22) in a second direction opposite the first direction.

4. The headnet (20) of claim 3, wherein the second pair of straps (28a, 28b) includes:
a third strap (28a) coupled to the edge portion first area (26a) and extending laterally from the head covering (22) in the first direction; and
a fourth strap (28b) coupled to the edge portion second area (26b) and extending laterally from the head covering (22) in the second direction.

5. The headnet (20) of claim 4, wherein the edge portion (26) further has a third area (26c) and a fourth area (26d) opposite the third area (26c), the headnet (20) further comprising a third pair of straps (30, 32) coupled to the head covering (22), the third pair of straps (30, 32) including:
a fifth strap (30) coupled to the edge portion third area (26c) and extending laterally from the head covering (22) in a third direction; and
a sixth strap (32) coupled to the edge portion fourth area (26d) and extending laterally from the head covering (22) in a fourth direction opposite the third direction.

6. The headnet (20) of claim 1, wherein the opening (36) has an edge portion (38) that is reinforced.

7. The headnet (20) of claim 1, wherein the first (24a, 24b) and second (28a, 28b) pairs of straps are couplable to a personal protective equipment mask facepiece (44).

8. The headnet (20) of claim 7, wherein the headnet (22) is configured to be worn under at least one of a hood and a helmet.

9. The headnet (20) of claim 1, wherein the opening (36) has an area of between 1.5 in² and 13.5 in².

10. The headnet (20) of claim 9, wherein the opening (36) has an area of between 2.4 in² and 4 in².

11. The headnet (20) of claim 1, wherein the head covering (22) is composed of at least one of a para-aramid synthetic fiber, polyester, and nylon.

12. The headnet (20) of claim 1, wherein the head covering (22) is composed of at least one of silicone and rubber.

13. A headnet (20) for use with personal protective equipment, the headnet (20) comprising:
a head covering (22) including:
an edge portion (26) having a first area (26a) and a second area (26b) opposite the first area (26a);
a first pocket (34a) extending from the edge portion first area (26a) to the edge portion second area (26b);
a second pocket (34b) located a predetermined distance from the first pocket (34a), the second pocket (34b) extending from the edge portion first area (26a) to the edge portion second area (26b); and
an aperture (36) between the first (34a) and second (34b) pockets;
a first strap (24) having a first portion (24a) extending from the edge portion first area (26a) in a first direction and a second portion (24b) extending from the edge portion second area (26b) in a second direction opposite the first direction, at least a portion of the first strap (24) being within the first pocket (34a); and
a second strap (28) having a first portion (28a) extending from the edge portion first area (26a) in the first direction and a second portion (28b) extending from the edge portion second area (26b) in the second direction, at least a portion of the second strap (28) being within the second pocket (34b).

14. The headnet (20) of claim 13, wherein the aperture (36) has an area of between 2.4 in² and 4 in².

15. The headnet (20) of claim 13, wherein the aperture (36) has an edge portion (38) that is reinforced.

16. The headnet (20) of claim 13, wherein the first (24) and second (28) straps are couplable to a personal protective equipment mask facepiece (44), the headnet (20) being configured to be worn under at least one of a hood and a helmet of a first responder.

17. The headnet (20) of claim 13, wherein the edge portion (26) further has a third area (26c) and a fourth area (26d) opposite the third area (26c), the headnet (20) further comprising:
a third strap (30) extending from the edge portion third area (26c) in a third direction; and
a fourth strap (32) extending from the edge portion fourth area (26d) in a fourth direction opposite the third direction.

18. A headnet (20) for personal protective equipment configured to be worn by a wearer having hair (46), the headnet (20) comprising
a head covering (22), the head covering (22) formed to cover the wearer's head (100), the head (100) having a face (106), a frontal bone area (102), a parietal bone area (108), and an occipital bone area (104), the head covering (22) being configured to cover the wearer's head (100) from the frontal bone area (102) to the occipital bone area (104) and to support protective turnout gear for respiratory protection;
a first set of straps (24a, 24b), the first set of straps (24a, 24b) including a left-extending strap (24a) and a right-extending strap (24b) with both straps (24a, 24b) extending laterally from the head covering (22) and forward to each side of the wearer's face (106) at a level approximate to the intersection of the wearer's parietal bone area (108) and occipital bone area (104);
a second set of straps (28a, 28b), the second set of straps (28a, 28b) including a left-extending strap (28a) and a right-extending strap (28b) with both straps (28a, 28b) extending laterally from the head covering (22) and forward to each side of the wearer's face (106) at a level approximate to a lower portion of the wearer's occipital bone area (104); and
an opening (36) formed within the head covering (22), the opening (36) being vertically centered with a back of the wearer's head (100) and being horizontally centered between the first (24a, 24b) and second (28a, 28b) sets of straps, the opening (36) having sufficient area for at least a portion of the wearer's hair (46) to pass therethrough.

19. The headnet (20) of claim 18, wherein the opening (36) has an area of between 2.4 in² and 4 in².

20. The headnet (20) of claim 18, wherein the opening (36) has an edge portion (38) that is reinforced.
